(19) United States
(12) Patent Application Publication
(10) Pub. No.: US 2025/0279945 A1
(43) Pub. Date: Sep. 4, 2025

(54) SUPPLEMENTATION OF ACTIVE PROBING WITH INFRASTRUCTURE TELEMETRY DATA

(71) Applicant: Cisco Technology, Inc., San Jose, CA (US)

(72) Inventors: Andrea Di Pietro, Parasols (FR); Yannick Weibel, Cugy (CH); Filippo Ardito, Mont-sur-Rollem (CH); Federico Lovison, Fontanelle (IT); Peter Van Eynde, Edegem (BE)

(73) Assignee: Cisco Technology, Inc., San Jose, CA (US)

(21) Appl. No.: 18/592,848

(22) Filed: Mar. 1, 2024

(51) Int. Cl. H04L 43/045; H04L 43/0811; H04L 43/10

(52) U.S. Cl. CPC H04L 43/045; H04L 43/0811; H04L 43/10

(57) ABSTRACT

In one implementation, a device identifies an endpoint in a local network configured to execute an endpoint agent that conducts active testing of network paths between the endpoint and one or more target destinations. The device sends a request to an infrastructure agent configured to obtain network telemetry data regarding the endpoint from the local network. The device receives, in response to the request, the network telemetry data. The device provides, to a user interface, an indication of results of the active testing by the endpoint agent based in part on the network telemetry data.

### TECHNICAL FIELD

The present disclosure relates generally to the supplementation of active probing with infrastructure telemetry data.

### BACKGROUND

Network assurance systems play a central role in maintaining the integrity, performance, and reliability of network infrastructure and processes. Often, these systems rely on endpoint agents that perform synthetic testing, to detect end-to-end failures. For instance, one endpoint agent may send probe packets towards a particular online application or service, to assess the performance of the network connection to that application or service.

An endpoint agent, though, only provides limited visibility from a singular vantage point. In addition, certain network issues are not detectable from the standpoint of an endpoint agent. For instance, consider the case in which the endpoint itself is connected to a congested access point or cannot onboard onto the wireless network at all. In such a case, the network assurance service will be unable to obtain telemetry data from the endpoint agent, without any indication as to why.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of an architecture 400 for supplementation of active probing with infrastructure telemetry data in accordance with implementations of the present disclosure; and

FIG. 5 illustrates an example simplified procedure for supplementation of active probing with infrastructure telemetry data in accordance with implementations of the present disclosure.

### DESCRIPTION OF EXAMPLE IMPLEMENTATIONS

### Overview

According to one or more implementations of the disclosure, a device identifies an endpoint in a local network configured to execute an endpoint agent that conducts active testing of network paths between the endpoint and one or more target destinations. The device sends a request to an infrastructure agent configured to obtain network telemetry data regarding the endpoint from the local network. The device receives, in response to the request, the network telemetry data. The device provides, to a user interface, an indication of results of the active testing by the endpoint agent based in part on the network telemetry data.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

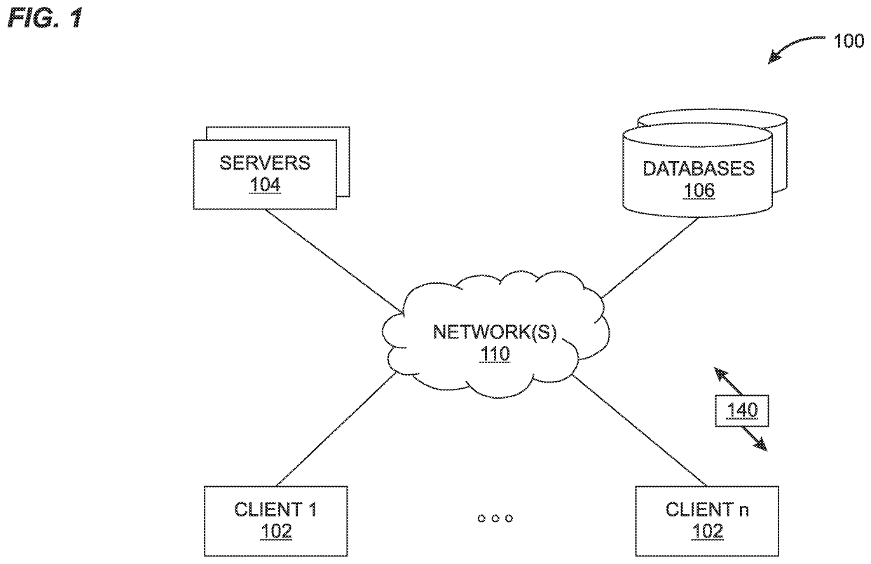

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

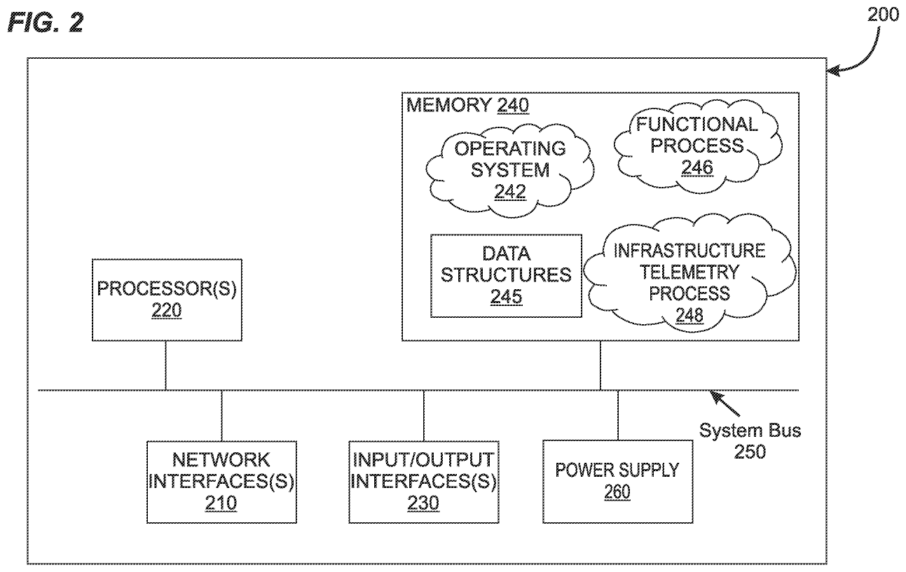

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an infrastructure telemetry process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

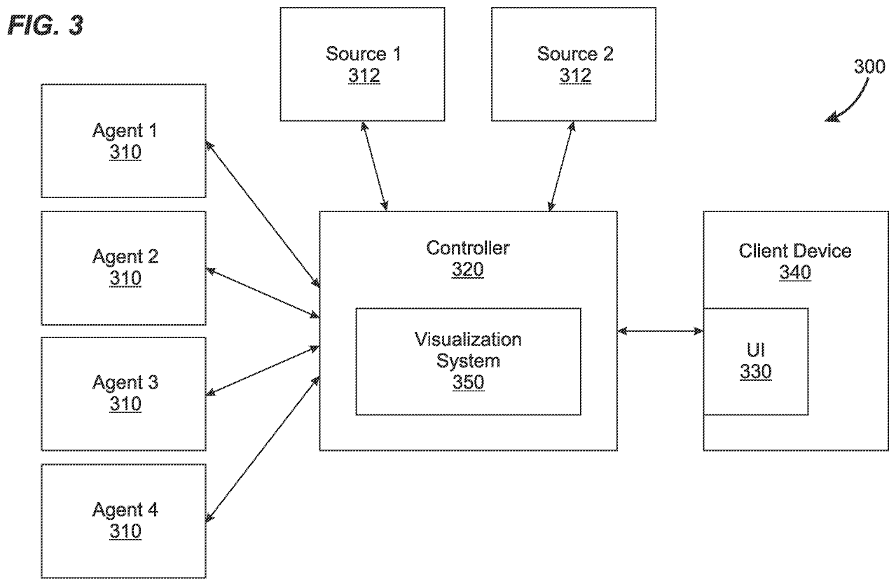

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (e.g., agents 310), one or more sources (e.g., sources 312), and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a user interface 330 (denoted UI in FIG. 3), such as a browser-based UI, that is the primary interface for monitoring, analyzing, and troubleshooting the monitored environment. Specifically, the controller 320 can receive data from agents 310, sources 312 (and/or other coordinator devices), associate portions of data (e.g., topology, transaction end-to-end paths and/or metrics, etc.), communicate with agents to configure collection of the data (e.g., the instrumentation/tests to execute), and provide performance data and reporting through user interface 330. User interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller 320 may be installed locally and self-administered.

The controllers 320 receive data from the agents 310 (e.g., Agents 1-4) and/or sources 312 deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application. Further, the controllers 320 can receive data from sources 312 (e.g., sources 1-2). Any of the sources can be implemented to provide various types of observability data that can include information, metrics, telemetry data, business data, network data, etc.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be implemented as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

An application transaction, in particular, is a representation of the particular service provided by the monitored environment that provides a view on performance data in the context of the various tiers that participate in processing a particular request. That is, an application transaction, which may be identified by a unique application transaction identification (ID), represents the end-to-end processing path used to fulfill a service request in the monitored environment (e.g., adding items to a shopping cart, storing information in a database, purchasing an item online, etc.). Thus, an application transaction is a type of user-initiated action in the monitored environment defined by an entry point and a processing path across application servers, databases, and potentially many other infrastructure components. Each instance of an application transaction is an execution of that transaction in response to a particular user request (e.g., a socket call, illustratively associated with the TCP layer). An application transaction can be created by detecting incoming requests at an entry point and tracking the activity associated with request at the originating tier and across distributed components in the application environment (e.g., associating the application transaction with a 4-tuple of a source IP address, source port, destination IP address, and destination port). A flow map can be generated for an application transaction that shows the touch points for the application transaction in the application environment. In one implementation, a specific tag may be added to packets by application specific agents for identifying application transactions (e.g., a custom header field attached to a hypertext transfer protocol (HTTP) payload by an application agent, or by a network agent when an application makes a remote socket call), such that packets can be examined by network agents to identify the application transaction identifier (ID) (e.g., a Globally Unique Identifier (GUID) or Universally Unique Identifier (UUID)). Performance monitoring can be oriented by application transaction to focus on the performance of the services in the application environment from the perspective of end users. Performance monitoring based on application transactions can provide information on whether a service is available (e.g., users can log in, check out, or view their data), response times for users, and the cause of problems when the problems occur.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or application transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be implemented across multiple devices, on different devices, utilizing additional devices, and so on, and the views shown herein are merely simplified examples that are not meant to be limiting to the scope of the present disclosure.

As noted above, contemporary network assurance systems based on synthetic tests are only able to provide visibility from a single endpoint and cannot reveal a number of network specific issues (e.g., congested APs, onboarding issues etc.) which can only be detected by using infrastructure-internal telemetry.

To this end, agents running on infrastructural devices (e.g., APs, switches, routers) are being deployed in order to complement the endpoint-centric perspective with global information about the local network. While sitting on infrastructural devices, such agents could retrieve a wide range of network telemetry, ranging from device configuration and interface counts to NetFlow records or client onboarding events.

The information such agents can export, though, is hampered by limiting factors such as: privacy related regulations prevents from exporting data related to all network hosts (e.g., this may be particularly sensitive for network guests which are not part of the organizations); the sheer amount of data that exporting all of the available telemetry would generate; and/or that, until the client has connectivity, the agent on the client cannot send data so any failures cannot be correlated with events observed by the infrastructure.

—Supplementation of Active Probing with Infrastructure Telemetry Data—

In contrast, the techniques herein leverage the full richness of the available network data while overcoming the limitations outlined above. These techniques introduce an architecture which allows exporting fine grained networking telemetry which may only be relevant to the available endpoint agents. By doing this the privacy issue (e.g., endpoints running an agent are organization monitored anyhow) and the data volume issue (e.g., detailed telemetry is only exported for a subset of endpoints) are ameliorated. As such, the techniques described herein provide a solution for exporting contextual network telemetry to complement statistics generated by using active probing. Careful selection of the telemetry sources ensures that privacy constraints are addressed and that the amount of exported data is manageable.

Illustratively, the techniques described herein may be performed by hardware, software, and/or firmware, such as in accordance with infrastructure telemetry process 248, which may include computer executable instructions executed by the processor 220 (or independent processor of interfaces 210) to perform functions relating to the techniques described herein.

Specifically, according to various implementations, a device identifies an endpoint in a local network configured to execute an endpoint agent that conducts active testing of network paths between the endpoint and one or more target destinations. The device sends a request to an infrastructure agent configured to obtain network telemetry data regarding the endpoint from the local network. The device receives, in response to the request, the network telemetry data. The device provides, to a user interface, an indication of results of the active testing by the endpoint agent based in part on the network telemetry data.

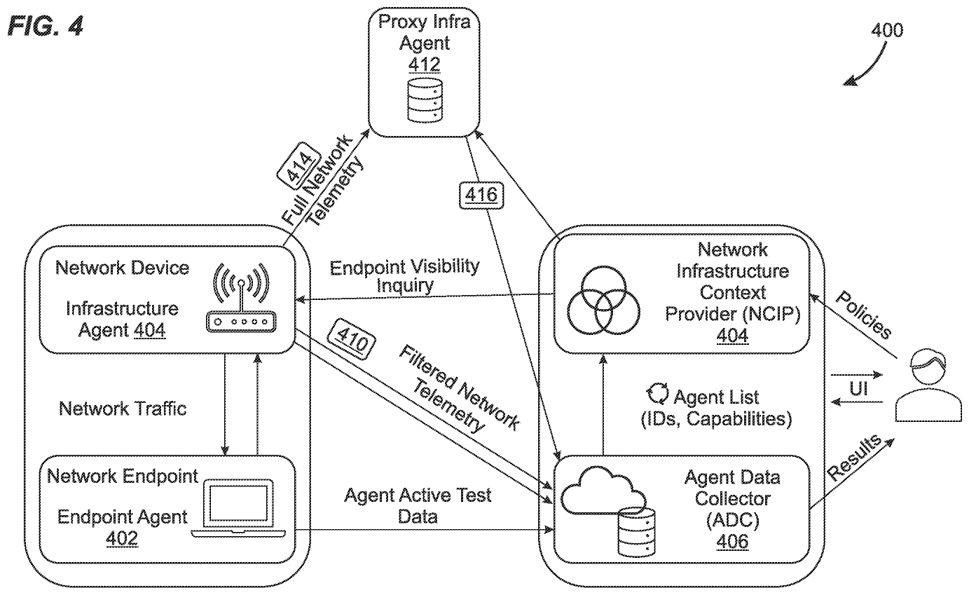

Operationally, FIG. 4 illustrates an example of an architecture 400 for the supplementation of active probing with infrastructure telemetry data. Current network performance monitoring and diagnostics systems (e.g., ThousandEyes by Cisco Systems, Inc.) may utilize active probing (e.g., generating and/or sending synthetic traffic or test packets across the network to simulate user transactions or network operations) to collect telemetry data on network performance. For instance, this network performance data may include metrics such as latency, packet loss, path routing, etc.

These conventional network performance monitoring and diagnostic systems mostly rely on a number of different components such as those outlined above with respect to observability intelligence platform 300. For example, these systems may utilize endpoint agents (e.g., endpoint agent 402) which perform end-to-end active tests from the monitored client to an endpoint on the network. Such agents are not limited to run on laptops, but can also be supported by IP phones, teleconferencing devices, wireless active sensors, etc.

Another example of a component of these types of systems is infrastructure agents (e.g., infrastructure agent 404) which run on network devices (e.g., APs, switches, routers, network infrastructure management appliances, RADIUS servers/ISE, etc.). The infrastructure agents may be configured to collect network telemetry data and/or to perform additional end-to-end tests. The type of data may be dependent upon which kind of device the agents run on (e.g., it may include NetFlow data, onboarding events, etc.).

An additional component of these systems can be a cloud agent data collector (ADC 406). ADC 406 may receive the data from all the deployed agents (be them enterprise or endpoint), correlate them, and/or present them to the end user through a UI.

The implementations described herein may facilitate the provision of fine-grained network telemetry for complementing the visibility provided by active measurements. In some instances, this supplemental data may be leveraged to cover some of the blind spots of the active testing approach.

In order to perform any active tests, both the enterprise and the endpoint agents may need to have full internet reachability, relying on Layer 3 connectivity at the access devices in the first hops. Therefore, network issues impacting Layer 2 connectivity (e.g., wireless onboarding issues, or 802.1X errors) or failure to communicate at IP layer (e.g., DHCP address allocation) may not, by definition, be revealed by an endpoint agent 402 until the agent has not successfully connected, the cloud data collector cannot distinguish between an endpoint which is experiencing onboarding issues, and/or an endpoint which has just been turned off.

However, the network infrastructure itself has full visibility about such kind of issues and oftentimes may provide rich telemetry which facilitates problem pinpointing and troubleshooting. Onboarding events from both wired and wireless may reveal that the client is in fact failing to connect.

In various implementations, if the endpoint has no full layer 3 connectivity but can still send messages locally, the endpoint agent 402 may communicate with the infrastructure agents (e.g., infrastructure agent 404) to enrich understanding of the connectivity problems with the information seen on the client, and more importantly the identity of the client. This identity is often difficult to obtain before the client is online due to privacy protections (e.g., random MAC, probing with random data, etc.).

In some instances, the provision of infrastructure-side statistics may help contextualize the results of active tests. For example, an endpoint may be experiencing diminished wireless throughput attributable to its association with an AP that is experiencing high levels of congestion. Typically, the number of clients connected to the AP would be visible to the infrastructure only.

In order to provide such information, a Network Infrastructure Context Provider (NICP 408) is introduced. NICP 408 may manage provision of such additional information to the ADC 406. The NICP 408 may receive from the ADC 406 a list of all endpoints and enterprise agents available for each customer, along with all of their available identifiers. Such identifiers can include the endpoint MAC addresses, its device unique identifier (e.g., in instances where the endpoint is using MAC randomization), its IP addresses, and/or any other information which could allow identifying the endpoint. In various implementations, such information may be anonymized. For example, the list of endpoint identifiers can be transformed through a one-way hash so that such sensitive information is not communicated directly to the on-prem devices.

Notice that this information is available once an endpoint agent 402 registers with the ADC 406 and is regularly updated. The NICP 408 may also receive a list of the available infrastructure agents (e.g., infrastructure agent 404) for each customer. In some instances, this list can include metadata for each of the infrastructure agents, such as the type of device and the site where it is located.

Periodically, the NICP 408 may send an endpoint visibility inquiry message to each of the infrastructure agents (e.g., infrastructure agent 404), which may include the list of potential endpoints to monitor. In various implementations, the list can be customized according to the infrastructure agent metadata (e.g., if the agent is running on an AP, endpoints with no wireless capabilities will be excluded).

Each infrastructural agent (e.g., infrastructure agent 404) may check the received list against the list of endpoints currently observable in the device and/or the type of telemetry available on the device. The infrastructure agent 404 may respond to the endpoint visibility inquiry message by reporting the result of such matching.

The NICP 408, upon receiving this response, may make a decision regarding which endpoint-related telemetry is to be collected on which infrastructure agent. Such a decision can be made according to the policies specified by a user (e.g., customer, administrator, etc.). Such policies may include which network devices should be preferred for telemetry collection (e.g., the customer may prefer to export from a wireless LAN controller (WLC) rather than exporting from APs), which kind of telemetry is allowed to be exported (e.g., the customer may still have privacy concerns), whether to sample some telemetry sources or to rate-limit them, the aggregation method to use to limit rate and reduce privacy concerns (e.g., NetFlow aggregated by application type, aggregation by source IP, etc.), compliance with location-based policies (e.g. general data protection regulation (GPDR)), etc.

After making such a decision, the NICP 408 may send an endpoint telemetry collection message to the infrastructure agent 404. Upon receiving such message, the infrastructure agent 404 may start exporting (e.g., at box 410) the requested telemetry to the ADC 406.

Additionally, or alternatively, the architecture 400 may include a proxy infrastructure agent 412 component. For instance, in some cases, telemetry information may not have to be exported directly by local infrastructure agents to the ADC 406 as the enterprise network may already collect and/or export (e.g., at box 414) this data to the cloud. This may be the case, for example, for customers of network infrastructure management products that enable the AI-based network analytics features, which already exports a large variety of network telemetry to the cloud.

In various implementations, proxy infrastructure agent 412 may be utilized as an abstraction to represent all the data already available in the cloud. Proxy infrastructure agent 412 may provide the same interface as a standard infrastructure agent but perform a query to its underlying telemetry data lakehouse in order to provide data (e.g., at box 416) to the ADC 406. In various implementations, if the information in the data lakehouse is anonymized, the proxy infrastructure agent 412 may be responsible for performing the mapping between the cleartext and the anonymized version of the endpoint identifiers, so that the deanonymization key is never co-located with the data lakehouse.

Regardless of whether the infrastructure telemetry data is exported directly from the infrastructure agent 404 of a network device or from the proxy infrastructure agent 412 from a data lakehouse, this additional infrastructure telemetry data may be incorporated with and/or utilized to supplement active probing data. That is, the infrastructure telemetry data may be provided to users to deliver important contextual network telemetry to complement statistic generated by using active probing. By careful selection of the telemetry sources, assurances are provided that privacy constraints are addressed and that the amount of exported data is manageable.

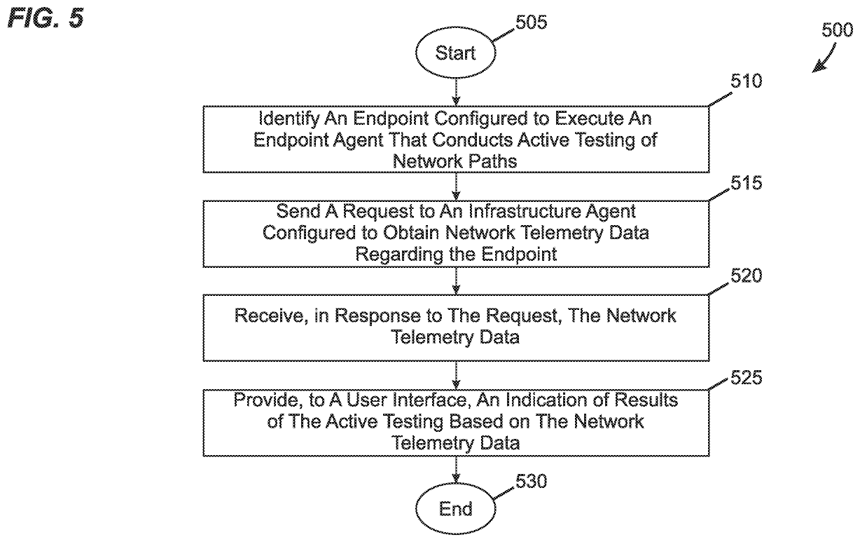

FIG. 5 illustrates an example simplified procedure 500 for supplementation of active probing with infrastructure telemetry data, in accordance with one or more implementations described herein. For example, a non-generic, specifically configured device (e.g., device 200), may perform procedure 500 (e.g., a method) by executing stored instructions (e.g., infrastructure telemetry process 248). The procedure 500 may start at step 505, and continues to step 510, where, as described in greater detail above, the device (e.g., a controller, processor, etc.) may identify an endpoint in a local network that is configured to execute an endpoint agent. The endpoint agent may conduct active testing of network paths between the endpoint and one or more target destinations. The active testing may entail the endpoint agent sending probe packets towards the one or more target destinations. The one or more target destinations may be services accessible via the Internet and that are external to the local network.

At step 515, as detailed above, the device may send a request to an infrastructure agent. The infrastructure agent may be configured to obtain network telemetry data regarding the endpoint from the local network. In some instances, the infrastructure agent is a proxy agent that collects the network telemetry data from a data structure (e.g., a cloud-based data lake) storing network telemetry data from networking equipment in the local network. In various implementations, a device may select networking equipment executing the infrastructure agent to which the request is to be sent, according to a policy specified via the user interface.

At step 520, the device may receive, in response to the request, the network telemetry data, as described in greater detail above. The network telemetry data may be based on network traffic between networking equipment executing the infrastructure agent and the endpoint. The network telemetry data may indicate a lack of connectivity by the endpoint. The network telemetry data may indicate a wireless onboarding issue associated with the endpoint. In some instances, the network telemetry data may indicate a failure to communicate at the IP layer associated with the endpoint.

At step 525, as detailed above, the device may provide, to a user interface, an indication of results of the active testing by the endpoint agent based in part on the network telemetry data. The indication provided to the user interface may indicate that the endpoint agent was unable to perform its active testing because of the lack of connectivity.

Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, provides a solution for exporting contextual network telemetry to complement statistics generated by using active probing. Careful selection of the telemetry sources ensures that privacy constraints are addressed and that the amount of exported data is manageable. The secure and resource-conscious targeted integration of additional infrastructure data directly overcomes the limiting factors of existing network monitoring approaches and offers a more nuanced and comprehensive view of network health beyond what is achievable with existing endpoint-centric active probing alone.

By incorporating telemetry from infrastructure devices such as APs, switches, routers, etc., these techniques can identify and diagnose issues that are invisible to traditional endpoint-based methods, such as congestion, onboarding problems, Layer 2 connectivity issues, etc. The resulting enriched data set facilitates a deeper analysis of the network, providing the identification of root causes of performance degradation and ensuring a more robust and resilient network infrastructure. Consequently, network administrators can proactively manage and optimize the network without running afoul of privacy concerns and data handling resource constraints, significantly enhancing the overall user experience and reducing downtime.

While there have been shown and described illustrative implementations that provide for secure and manageable supplementation of active probing with infrastructure telemetry data, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
identifying, by a device, an endpoint in a local network configured to execute an endpoint agent that conducts active testing of network paths between the endpoint and one or more target destinations;
sending, by the device, a request to an infrastructure agent configured to obtain network telemetry data regarding the endpoint from the local network;
receiving, at the device and in response to the request, the network telemetry data; and
providing, by the device and to a user interface, an indication of results of the active testing by the endpoint agent based in part on the network telemetry data.

2. The method as in claim 1, wherein the one or more target destinations are services accessible via Internet and external to the local network.

3. The method as in claim 1, wherein the active testing entails the endpoint agent sending probe packets towards the one or more target destinations.

4. The method as in claim 1, further comprising:
selecting networking equipment executing the infrastructure agent to which the request is to be sent, according to a policy specified via the user interface.

5. The method as in claim 1, wherein the network telemetry data indicates a lack of connectivity by the endpoint.

6. The method as in claim 5, wherein the network telemetry data indicates a wireless onboarding issue associated with the endpoint.

7. The method as in claim 5, wherein the indication provided to the user interface indicates that the endpoint agent was unable to perform its active testing because of the lack of connectivity.

8. The method as in claim 1, wherein the infrastructure agent is a proxy agent that collects the network telemetry data from a data structure storing network telemetry data from networking equipment in the local network.

9. The method as in claim 1, wherein the network telemetry data indicates a failure to communicate at IP layer associated with the endpoint.

10. The method as in claim 1, wherein the network telemetry data is based on network traffic between networking equipment executing the infrastructure agent and the endpoint.

11. An apparatus, comprising:
one or more network interfaces;
a processor coupled to the one or more network interfaces and configured to execute one or more processes; and
a memory configured to store a process that is executable by the processor, the process when executed configured to:
identify an endpoint in a local network configured to execute an endpoint agent that conducts active testing of network paths between the endpoint and one or more target destinations;
send a request to an infrastructure agent configured to obtain network telemetry data regarding the endpoint from the local network;
receive, in response to the request, the network telemetry data; and
provide, to a user interface, an indication of results of the active testing by the endpoint agent based in part on the network telemetry data.

12. The apparatus as in claim 11, wherein the one or more target destinations are services accessible via Internet and external to the local network.

13. The apparatus as in claim 11, wherein the active testing entails the endpoint agent sending probe packets towards the one or more target destinations.

14. The apparatus as in claim 11, wherein the process when executed is further configured to:
select networking equipment executing the infrastructure agent to which the request is to be sent, according to a policy specified via the user interface.

15. The apparatus as in claim 11, wherein the network telemetry data indicates a lack of connectivity by the endpoint.

16. The apparatus as in claim 15, wherein the network telemetry data indicates a wireless onboarding issue associated with the endpoint.

17. The apparatus as in claim 15, wherein the indication provided to the user interface indicates that the endpoint agent was unable to perform its active testing because of the lack of connectivity.

18. The apparatus as in claim 11, wherein the infrastructure agent is a proxy agent that collects the network telemetry data from a data structure storing network telemetry data from networking equipment in the local network.

19. The apparatus as in claim 11, wherein the network telemetry data indicates a failure to communicate at IP layer associated with the endpoint.

20. A tangible, non-transitory, computer-readable medium storing program instructions that cause a device to execute a process comprising:
identifying an endpoint in a local network configured to execute an endpoint agent that conducts active testing of network paths between the endpoint and one or more target destinations;
sending a request to an infrastructure agent configured to obtain network telemetry data regarding the endpoint from the local network;
receiving, in response to the request, the network telemetry data; and
providing, to a user interface, an indication of results of the active testing by the endpoint agent based in part on the network telemetry data.
